(19) United States
(12) Patent Application Publication
(10) Pub. No.: US 2017/0307360 A1
(43) Pub. Date: Oct. 26, 2017

(54) STATUS DETERMINATION DEVICE AND STATUS DETERMINATION METHOD

(71) Applicant: NEC Corporation, Minato-ku, Tokyo (JP)

(72) Inventor: Hiroshi IMAI, Tokyo (JP)

(73) Assignee: NEC Corporation, Minato-ku, Tokyo (JP)

(21) Appl. No.: 15/507,810

(22) PCT Filed: Sep. 15, 2015
(86) PCT No.: PCT/JP2015/004682

§ 371 Date: Mar. 1, 2017

(30) Foreign Application Priority Data
Sep. 25, 2014 (JP) 2014-194538

(51) Int. Cl. G01B 11/16; G01M 5/00; G01M 11/08; G06T 7/246; G01B 11/25

(52) U.S. Cl. CPC G01B 11/165; G01M 11/081; G06T 7/246; G01M 5/005; G01B 11/2518

(57) ABSTRACT

The present invention addresses the problem of making it possible to distinguish and detect cracking, peeling, internal cavities, and other defects through the remote observation of a structure. A status determination device according to the present invention is provided with a displacement calculation unit for calculating a two-dimensional spatial distribution of the displacement of a structure surface from time series images of the structure surface before and after load application and an abnormality determination unit for identifying flaws in the structure on the basis of a comparison of the two-dimensional spatial distribution and an already provided spatial distribution of displacement.

### TECHNICAL FIELD

The present invention relates to a device for determining a status of a structure and a method for determining a status of a structure.

### BACKGROUND ART

It is known that, in a concrete structure such as a tunnel and a bridge, cracking, peeling, an internal cavity and the like occurring on a surface of a structure affect soundness of the structure. Thus, in order to accurately determine the soundness of the structure, it is necessary to accurately detect the cracking, the peeling, the internal cavity and the like.

Detection of cracking, peeling, an internal cavity and the like of a structure has been performed through visual inspection and hammering inspection by an inspector, and for inspection, the inspector needs to approach the structure. Accordingly, there arises a problem, such as increase in operational cost due to arrangement of an environment to allow aerial work, and loss in economic opportunity due to traffic control for setting up a work environment. In view of this, a method of remotely inspecting a structure by an inspector is desired.

As a method of remotely determining soundness of a structure, there is a method using image measurement. For example, a technique of binarizing, by a predetermined threshold value, an image of a structure captured by image capturing means and detecting a part corresponding to cracking from the image has been proposed (PTL 1). In addition, a technique of detecting a crack as a defect generated in a structure, from a stress status of the structure (PTLs 2 and 3).

### CITATION LIST

### Patent Literature

[PTL 1] Japanese Unexamined Patent Application Publication No. 2003-035528

[PTL 2] Japanese Unexamined Patent Application Publication No. 2008-232998

[PTL 3] Japanese Unexamined Patent Application Publication No. 2006-343160

### SUMMARY OF INVENTION

### Technical Problem

In the method disclosed in PTL 1, a defect that is visible on a surface, such as cracking appearing on a surface of a structure, can be detected. However, peeling that looks like cracking but actually spreads over inside the structure in the same direction as the surface, an internal cavity that is invisible from the surface, and the like cannot be detected.

In addition, in the methods disclosed in PTLs 2 and 3, a crack generated in a structure can be detected from a stress status of the structure. However, a method of distinctively detecting various defects such as a crack, peeling, and an internal cavity is not disclosed.

The present invention has been made in light of the above-described problem, and an object of the present invention is to make it possible to distinctively detect a defect such as cracking, peeling, and an internal cavity by remotely observing a structure.

### Solution to Problem

A status determination device according to the present invention includes a displacement calculation unit that calculates, from time-series images before and after load application to a surface of a structure, a two-dimensional spatial distribution of displacement on the surface of the structure; and an abnormality determination unit that identifies a defect in the structure, based on comparison between the two-dimensional spatial distribution and a spatial distribution of displacement prepared in advance.

A status determination method according to the present invention includes calculating, from time-series images before and after load application to a surface of a structure, a two-dimensional spatial distribution of displacement on the surface of the structure; and identifying a defect in the structure, based on comparison between the two-dimensional spatial distribution and a spatial distribution of displacement prepared in advance.

### Advantageous Effects of Invention

The present invention makes it possible to distinctively detect a defect such as cracking, peeling, and an internal cavity by remotely observing a structure.

### BRIEF DESCRIPTION OF DRAWINGS

FIG. 1 is a block diagram illustrating a configuration of a status determination device according to an example embodiment of the present invention;

FIG. 2A is a diagram for describing a relationship between an abnormal status (in a case of being sound) and a surface displacement of a structure;

FIG. 2B is a diagram for describing a relationship between an abnormal status (in a case of cracking) and a surface displacement of a structure;

FIG. 2C is a diagram for describing a relationship between an abnormal status (in a case of peeling) and a surface displacement of a structure;

FIG. 2D is a diagram for describing a relationship between an abnormal status (in a case of an internal cavity) and a surface displacement of a structure;

FIG. 3A is a diagram illustrating a result of processing, at a displacement calculation unit, images of a lower face of a structure (in a case of being sound) before and after loading;

FIG. 3B is a diagram illustrating a result of processing, at the displacement calculation unit and a differential displacement calculation unit, images of a lower face of a structure (in a case of being sound) before and after loading;

FIG. 3C is a diagram illustrating a result of processing, at the displacement calculation unit, images of a lower face of a structure (in a case of cracking) before and after loading;

FIG. 3D is a diagram illustrating a result of processing, at the displacement calculation unit and the differential displacement calculation unit, images of a lower face of a structure (in a case of cracking) before and after loading;

FIG. 4A is a diagram illustrating a distribution of a stress field around cracking;

FIG. 4B is a diagram illustrating a distribution of a stress field around cracking;

FIG. 5A is a diagram illustrating an example of a two-dimensional distribution (X direction) of a displacement amount around cracking (in a case of shallow cracking);

FIG. 5B is a diagram illustrating an example of a two-dimensional distribution (Y direction) of a displacement amount around cracking (in a case of shallow cracking);

FIG. 5C is a diagram illustrating an example of a two-dimensional distribution (X direction) of a displacement amount around cracking (in a case of deep cracking);

FIG. 5D is a diagram illustrating an example of a two-dimensional distribution (Y direction) of a displacement amount around cracking (in a case of deep cracking);

FIG. 6A is a diagram describing pattern matching with a displacement distribution (a pattern of displacement for X direction) by an abnormality determination unit;

FIG. 6B is a diagram describing pattern matching with a displacement distribution (a pattern of displacement for Y direction) by the abnormality determination unit;

FIG. 6C is a diagram describing pattern matching with a displacement distribution (a pattern of a differential vector field of displacement) by the abnormality determination unit;

FIG. 7A is a perspective view illustrating a two-dimensional distribution of stress on a face as viewed from an image-capturing direction when an internal cavity is present;

FIG. 7B is a plan view illustrating a two-dimensional distribution of stress on a face as viewed from an image-capturing direction when an internal cavity is present;

FIG. 8A is a diagram illustrating contour lines (X component) of displacement on a face as viewed from an image-capturing direction when an internal cavity is present;

FIG. 8B is a diagram illustrating contour lines (Y component) of displacement on a face as viewed from an image-capturing direction when an internal cavity is present;

FIG. 8C is a diagram illustrating a stress field on a face as viewed from an image-capturing direction when an internal cavity is present;

FIG. 9A is a diagram describing a response in a case of applying an impulse stimulus to a structure when an internal cavity is present (illustrating locations A, B, and C for acquiring a response);

FIG. 9B is a diagram describing a response in a case of applying an impulse stimulus to a structure when an internal cavity is present (illustrating responses at locations A, B, and C);

FIG. 10A is a diagram illustrating contour lines (X component) of displacement on a face as viewed from an image-capturing direction when peeling is present;

FIG. 10B is a diagram illustrating contour lines (Y component) of displacement on a face as viewed from an image-capturing direction when peeling is present;

FIG. 10C is a diagram illustrating a stress field on a face as viewed from an image-capturing direction when peeling is present;

FIG. 11 is a diagram describing a time response of displacement in a case of applying an impulse stimulus to a structure when peeling is present;

FIG. 12 is a flowchart illustrating a status determination method of the status determination device according to the example embodiment of the present invention; and

FIG. 13 is a block diagram illustrating a configuration of the status determination device according to the example embodiment of the present invention.

### DESCRIPTION OF EMBODIMENTS

An example embodiment of the present invention will be described below in detail with reference to the drawings. Note that the example embodiment described below is limited in a technically preferable manner for carrying out the present invention, but is not intended to limit the scope of the invention to the following.

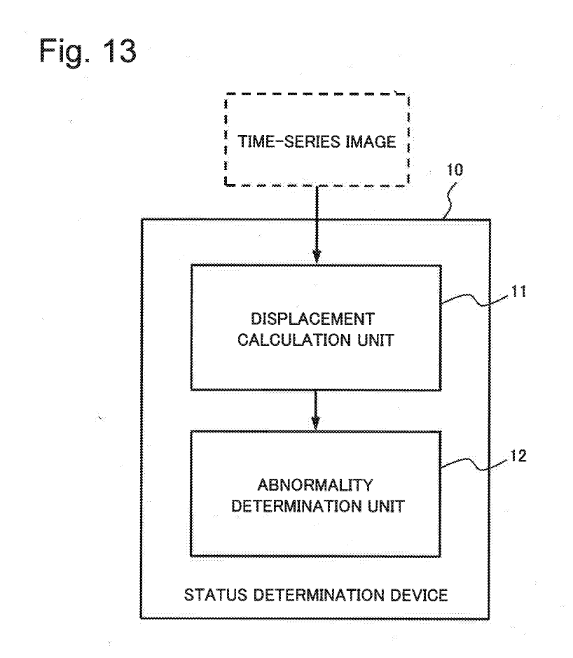

FIG. 13 is a block diagram illustrating a configuration of a status determination device according to the example embodiment of the present invention. A status determination device 10 according to the present example embodiment includes: a displacement calculation unit 11 that calculates, from time-series images before and after load application to a surface of a structure, a two-dimensional spatial distribution of displacement on the surface of the structure; and an abnormality determination unit 12 that identifies a defect in the structure, based on comparison between the two-dimensional spatial distribution and a spatial distribution of displacement prepared in advance. In addition, a direction of an arrow in the drawing indicates an example, but is not intended to limit a direction of a signal between blocks.

The present example embodiment makes it possible to distinctively detect a defect such as cracking, peeling, and an internal cavity by remotely observing a structure.

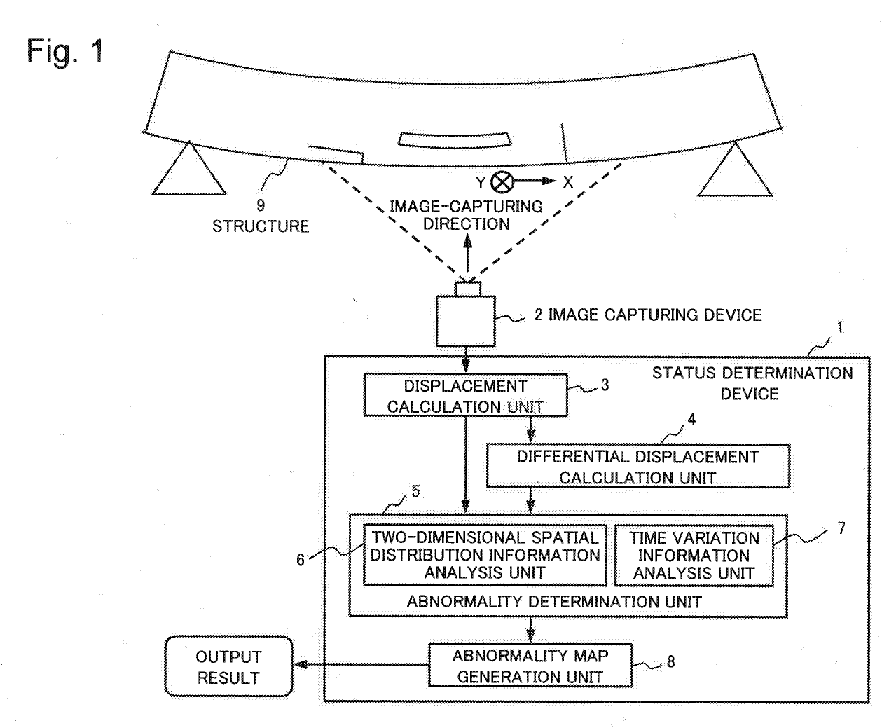

FIG. 1 describes the status determination device according to the present example embodiment more specifically. A status determination device 1 includes a displacement calculation unit 3, a differential displacement calculation unit 4, an abnormality determination unit 5, and an abnormality map generation unit 8. The abnormality determination unit 5 includes a two-dimensional spatial distribution information analysis unit 6 and a time variation information analysis unit 7. In addition, a direction of an arrow in the drawing indicates an example, but is not intended to limit a direction of a signal between blocks.

The status determination device 1 can be an information appliance such as a Personal Computer (PC) and a server. Each of the units constituting the status determination device 1 can be implemented by using a Central Processing Unit (CPU) as an operation resource of the information appliance and a memory and a Hard Disk Drive (HDD) as storage resources, and by causing the CPU to execute a program.

In FIG. 1, a structure 9 as an object to be measured is configured to have a shape of a two-point supported beam. Images of a surface of the structure 9 are captured as time-series images of X-Y plane by an image capturing device 2 before and after application of a load to the structure 9. The time-series images captured by the image capturing device 2 are input to the displacement calculation unit 3 of the status determination device 1.

The displacement calculation unit 3 calculates a displacement amount of each of the time-series images. In other words, the displacement calculation unit 3 calculates a displacement amount of a frame image at a first time after loading relative to a frame image as a reference captured by the image capturing device 2 before loading. Further, the displacement calculation unit 3 calculates, for each of the time-series images, a displacement amount relative to the image before loading in such a manner as to calculate a displacement amount of a frame image at a next time after loading and a displacement amount of a frame image at a time after the next. The displacement calculation unit 3 calculates a displacement amount by using image correlation operation. In addition, the displacement calculation unit 3 can also represent a two-dimensional spatial distribution of the calculated displacement amount on X-Y plane as a displacement distribution diagram.

The displacement amount or the displacement distribution diagram calculated by the displacement calculation unit 3 is input to the differential displacement calculation unit 4. The differential displacement calculation unit 4 spatially differentiates the displacement amount or the displacement distribution diagram, and calculates a differential displacement amount or a differential displacement distribution diagram as a two-dimensional differential spatial distribution of the calculated differential displacement amount on X-Y plane. Results of the calculation at the displacement calculation unit 3 and the differential displacement calculation unit 4 are input to the abnormality determination unit 5.

The abnormality determination unit 5 determines a status of the structure 9 based on the results of the calculation. In other words, the abnormality determination unit 5 determines a location and a type of an abnormality in the structure 9 from results of analysis at the two-dimensional spatial distribution information analysis unit 6 and the time variation information analysis unit 7. Further, the determined location and the type of the abnormality in the structure 9 are input to the abnormality map generation unit 8. The abnormality map generation unit 8 maps a spatial distribution of an abnormal status of the structure 9 on X-Y plane, records the spatial distribution as an abnormality map, and outputs the abnormality map.

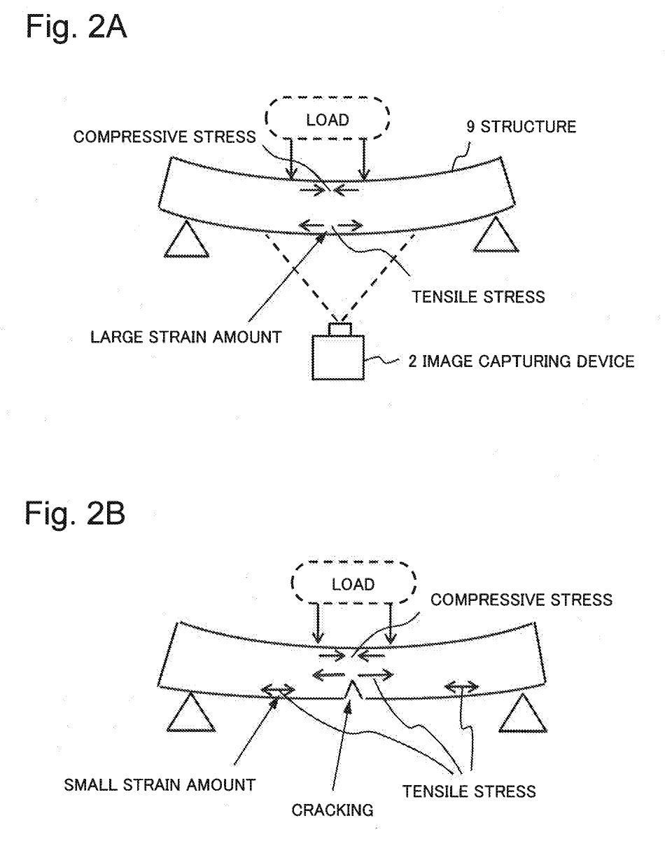

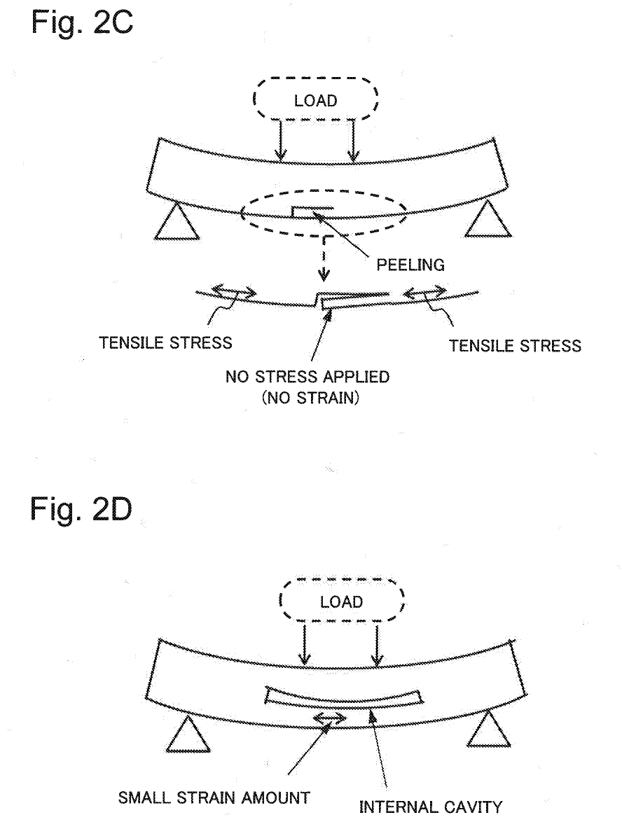

FIGS. 2A to 2D are diagrams each for describing a relationship between each of various abnormal status and a surface displacement of a structure 9. FIG. 2A is a side view of the two-point supported beam-shaped structure 9. As illustrated in FIG. 2A, the image capturing device 2 of FIG. 1 is arranged in a condition to capture an image of a lower surface of the structure 9. At this time, when the structure 9 is sound, a compressive stress and a tensile stress act on an upper face and a lower face of the structure 9, respectively, against a vertical load from the upper face of the structure 9, as illustrated in FIG. 2A. Note that the structure may not be particularly of a two-point supported beam shape on condition that a similar stress may act on the structure.

Herein, when the structure 9 is an elastic body, stress is proportional to strain. Young's modulus, which is a factor of proportionality of stress and strain, is dependent on a material of a structure. Since the strain proportional to the stress is a displacement per unit length, a strain can be calculated by spatially differentiating, at the differential displacement calculation unit 4, a result calculated at the displacement calculation unit 3. In other words, a stress field can be obtained from a result of the differential displacement calculation unit 4.

As illustrated in FIG. 2B, when cracking is present, a cracking part undergoes large opening displacement caused by a load. On the other hand, at a periphery of the cracking part, since the stress does not propagate due to the cracking part, the tensile stress acting on the lower face of the structure 9 is smaller than in the sound status illustrated in FIG. 2A.

In addition, as illustrated in FIG. 2C, when peeling is present, the appearance of the structure 9 as viewed from the lower face is observed as being similar to the appearance in the case of cracking. However, in a case of peeling, the stress does not propagate between a peeling part and an upper part thereof. Thus, the peeling part undergoes only a certain amount of parallel displacement in a certain direction before and after loading, but does not generate a strain, which is a spatial differential value of displacement. Therefore, by using information on the strain obtained by spatially differentiating displacement before and after loading, it becomes possible to distinguish between cracking and peeling.

In addition, as illustrated in FIG. 2D, when an internal cavity is present, since the stress is prevented from propagating through the internal cavity, the stress acting on the lower face of the structure 9 is small. Thus, since the strain to be calculated from an image is small as well, it is possible to find an internal cavity that is invisible directly from outside of the structure 9.

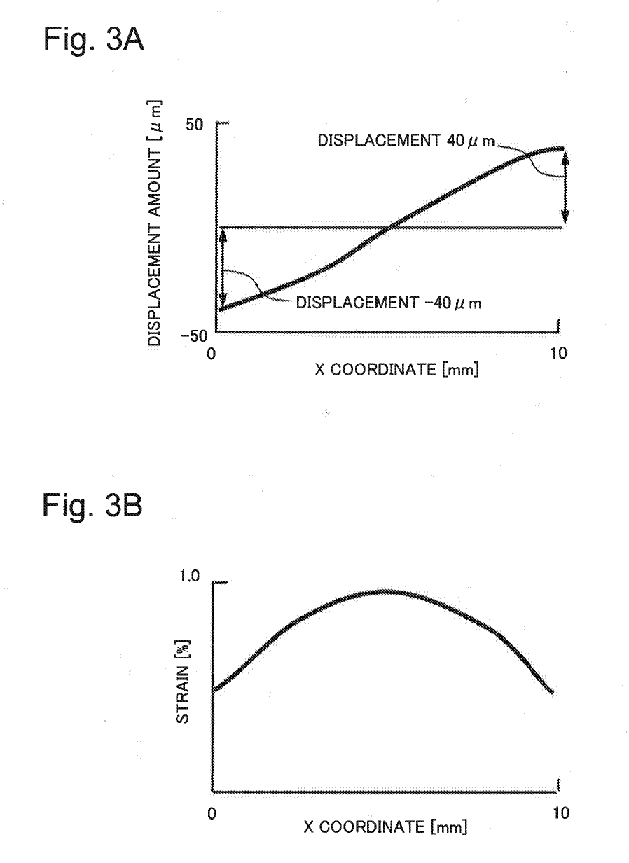

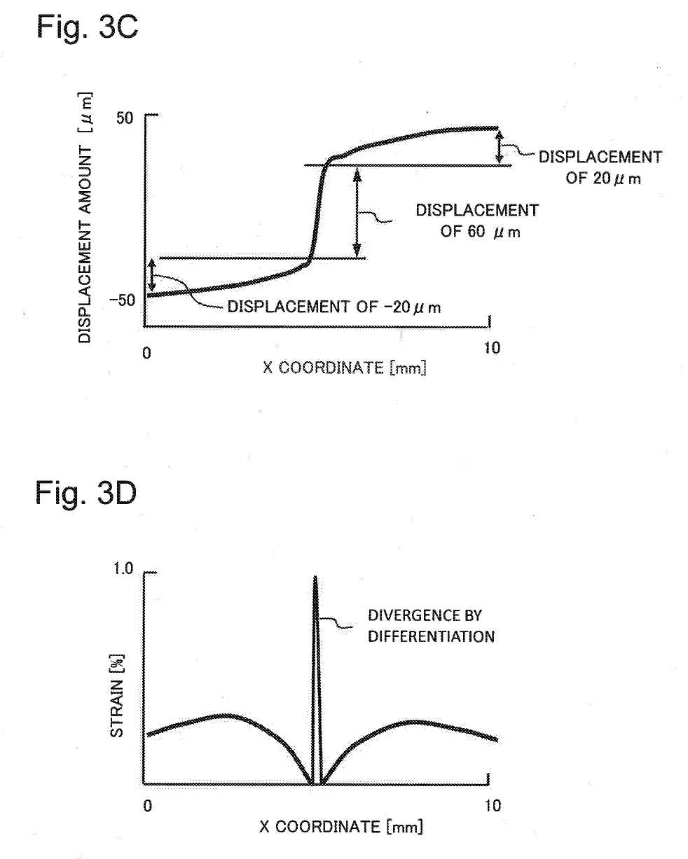

FIGS. 3A to 3D are diagrams each illustrating a result of processing, at the displacement calculation unit 3 and the differential displacement calculation unit 4, images of the beam-shaped structure 9 illustrated in FIG. 1 captured from an image-capturing direction before and after loading. It is assumed that the structure 9 is made of concrete (a Young's modulus of 40 GPa) having a length of 20 m, a thickness of 0.5 m, and a width of 10 m, and is a both ends-supported beam (a resonance frequency of 8 Hz, a maximum deflection amount of 4 mm) under a condition equivalent to a case of applying a load of 10 t. The diagrams are examples of measuring a displacement amount on a face in the image-capturing direction and a spatial differentiation (strain) of the displacement amount under the above condition.

FIG. 3A indicates a surface displacement before and after loading in a case of being sound, in which a displacement of ±40 μm occurs in a continuous manner without sharp change over a range of 10 mm. FIG. 3B indicates a result of spatially differentiating the result of FIG. 3A, in which the strain occurs at a maximum of about 0.9% within a range of 10 mm.

Meanwhile, FIG. 3C indicates a surface displacement before and after loading on a sample including cracking. At a cracking part, a sharp displacement of 60 μm occurs in a discontinuous manner. On the other hand, a periphery of the cracking part undergoes a displacement of ±20 μm over a range of 10 mm, which is smaller than in the sound status of FIG. 3A. FIG. 3D indicates a result of spatially differentiating the result of FIG. 3C. Since a differential value of displacement diverges at a cracking location, the strain sharply increases. On the other hand, the strain on both sides of the cracking location is about 0.25% at a maximum within a range of 10 mm, which is smaller in terms of the surface strain than in FIG. 3B. In addition, FIG. 3D shows a strain distribution having a local maximum at a boundary of the cracking part. From this result, it is possible to detect cracking, even when the cracking itself cannot be found from the appearance, by acknowledging a strain value that exceeds a threshold value preset for the strain value, for example.

According to mechanics of materials of an elastic body, the maximum deflection amount dependent on the displacement of the both ends-supported beam is proportional to the Young's modulus, is proportional to the cube of the length of the beam, is inverse proportional to the cube of the thickness of the beam, and is proportional to the width of the beam. Therefore, a result similar to FIGS. 3A to 3D can be also obtained for a structure made of another material with another size by capturing an enlarged or reduced image of the structure in accordance with the condition mentioned above.

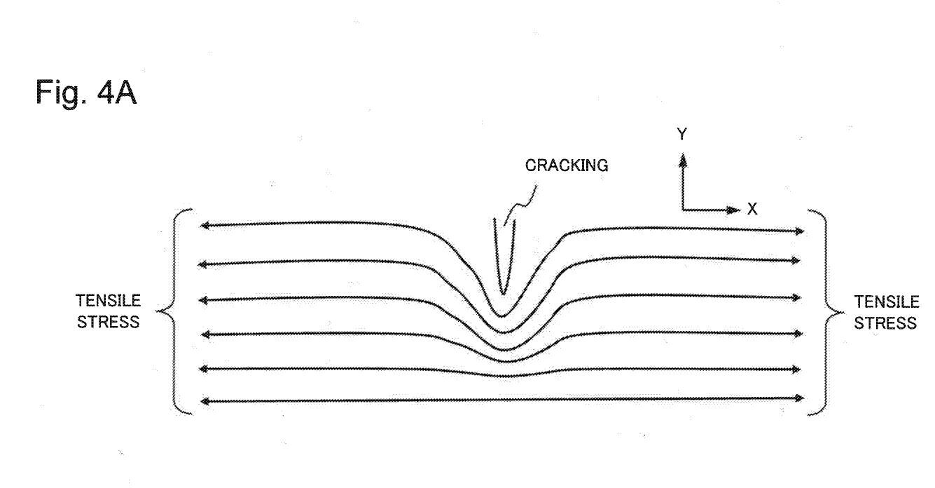

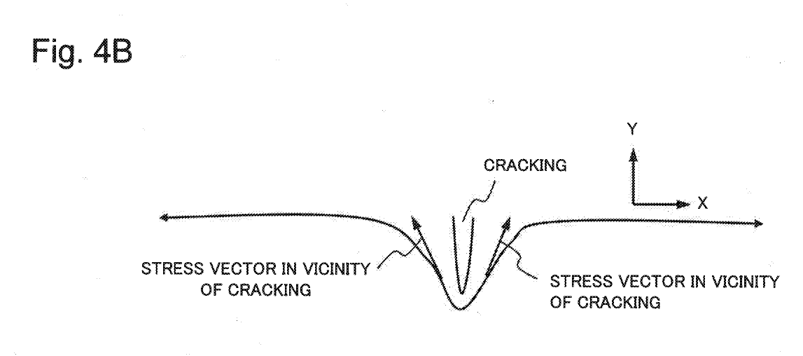

FIGS. 4A and 4B are diagrams each illustrating a distribution of a stress field around a cracking part calculated at the differential displacement calculation unit 4 when cracking is present. Since stress directions are bent by the cracking as illustrated in FIG. 4A, a stress direction in the vicinity of the cracking generates a Y-direction component as illustrated in FIG. 4B even when a tensile stress acts on both ends of the structure in X direction in FIG. 4A. Therefore, by the presence and the absence of the Y-direction component, cracking can be also detected. Note that since such a stress field around cracking is known for its distribution as a stress intensity factor in an elastic body showing a linear response, it is also possible to use information on the distribution.

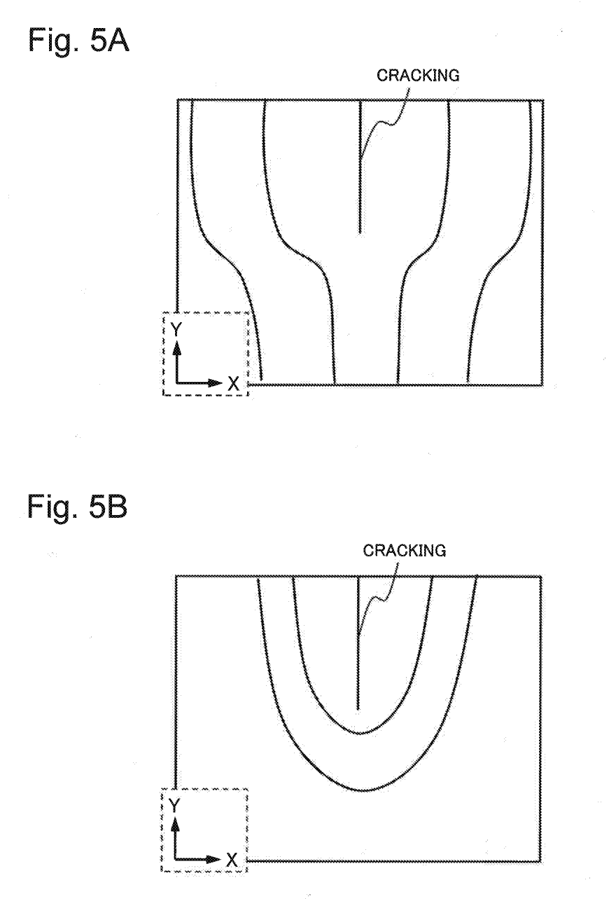

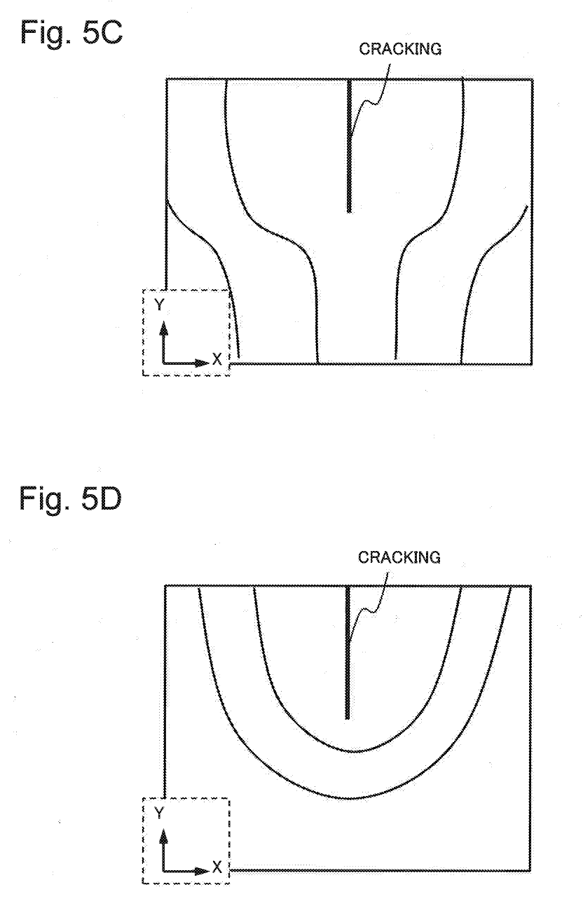

FIGS. 5A to 5D illustrate examples of a two-dimensional displacement distribution of a displacement amount around cracking. An experiment condition is equivalent to that in the case indicated in FIGS. 3A to 3D. FIGS. 5A and 5B illustrate displacement amount contour lines respectively in a horizontal direction (X direction) of FIG. 2B and in a direction (Y direction) perpendicular to the drawing of FIG. 2B. As illustrated in FIG. 5A, the density of the displacement amount contour lines for X direction is sparser around the cracking than that in a cracking-free area. This sparse part corresponds to the moderate displacement part outside the sharp displacement at the cracking part illustrated in FIG. 3C. The displacement at this part is more moderate than the displacement when the cracking is absent illustrated in FIG. 3A.

In addition, as illustrated in FIG. 5B, a Y-direction component is generated in the displacement for Y direction in the periphery of the cracking part. This component corresponds to the Y-direction component of the stress field (strain) illustrated in FIG. 4B.

FIGS. 5C and 5D illustrate cases of deeper cracking than in the cases of FIGS. 5A and 5B, respectively. In this case, the densities of the displacement amount contour lines for X direction and Y direction are sparser around the cracking. It is also possible to know the depth of the cracking from information on the sparseness and denseness.

The above cracking determination is carried out at the two-dimensional spatial distribution information analysis unit 6 in the abnormality determination unit 5 in FIG. 1.

When cracking is present, the displacement amount sharply increases at the cracking part in response to increase in a degree of opening of the cracking, as has been illustrated in FIG. 3C. Thus, by presetting each of threshold values of the displacement amount per unit length for X direction or Y direction, it can be estimated that cracking is present at a location where a displacement amount exceeding the threshold value is detected.

In addition, the strain in X direction sharply increases at the cracking part, as has been illustrated in FIG. 3D. From this fact, by presetting a threshold value for a value of the strain in X direction, it can be estimated that cracking is present at a location where a strain exceeding the threshold value is detected.

In addition, when cracking is present, the strain in Y direction is generated, as has been illustrated in FIGS. 4A and 4B. Thus, by presetting a threshold value for a value of the strain in Y direction, it can be estimated that cracking is present at a location where a strain exceeding the threshold value is detected.

Each of the above threshold values can be set through a simulation using a size and a material similar to those of a structure, an experiment by use of a miniature model, and the like. Further, each of the threshold values can be also set from accumulated data obtained by measuring an actual structure over a long period of time.

The above determination can be made not only by the comparison of numerical values as described above, but also by pattern matching processing as described below.

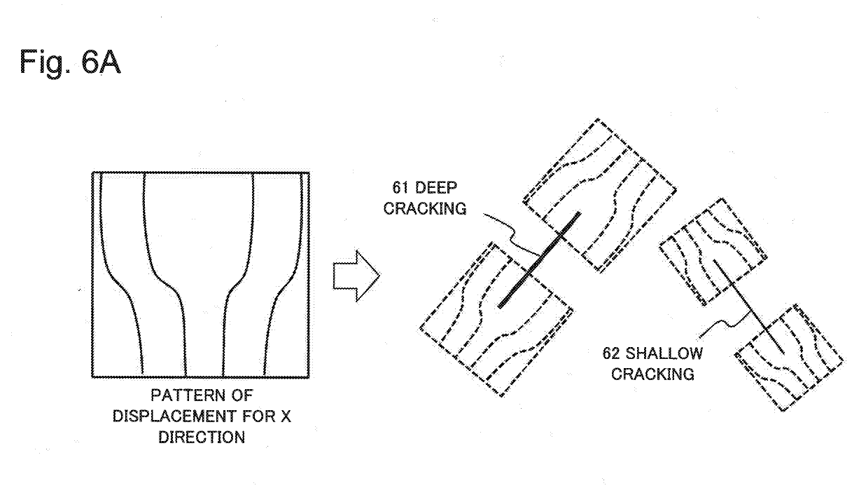

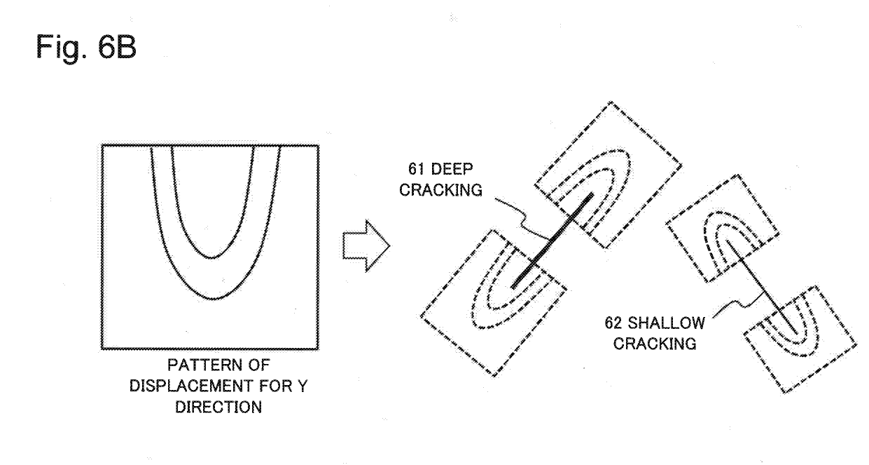

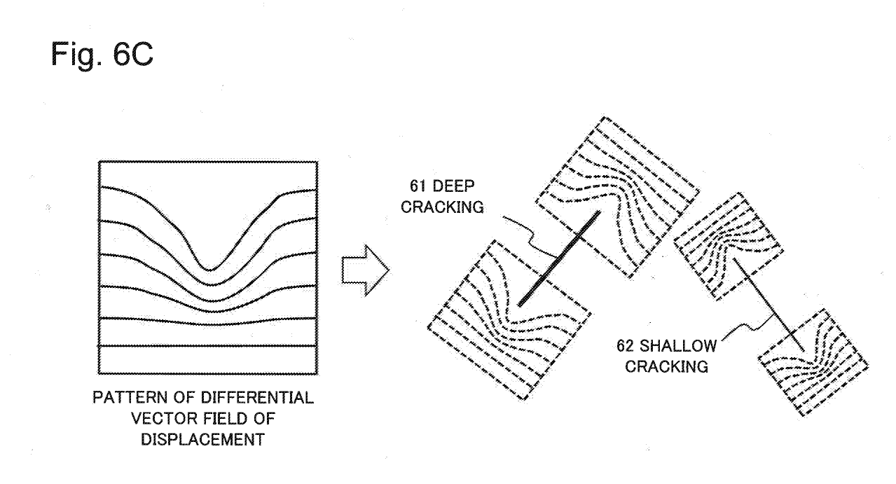

FIGS. 6A to 6C are diagrams describing pattern matching processing of displacement distributions by the two-dimensional spatial distribution information analysis unit 6. According to the displacement calculation unit 3 and the differential displacement calculation unit 4, a displacement amount can be represented on X-Y plane as a displacement distribution diagram, as has been illustrated in FIGS. 5A to 5D. As illustrated in FIG. 6A, the two-dimensional spatial distribution information analysis unit 6 is able to determine a direction and a depth of cracking by pattern-matching a prestored pattern of displacement around the cracking for X direction with the displacement distribution diagram obtained at the displacement calculation unit 3 while rotating, enlarging, and reducing the prestored pattern. Herein, the prestored pattern of displacement around the cracking for X direction is created in advance for each depth and each width of the cracking through a simulation and the like.

In addition, as illustrated in FIG. 6B, the two-dimensional spatial distribution information analysis unit 6 determines a direction and a depth of cracking by pattern-matching a prestored pattern of displacement around the cracking for Y direction with the displacement distribution diagram obtained at the displacement calculation unit 3 while rotating, enlarging, and reducing the prestored pattern. Herein, the prestored pattern of displacement around the cracking for Y direction is created in advance for each depth and each width of the cracking through a simulation and the like.

In addition, as illustrated in FIG. 6C, the two-dimensional spatial distribution information analysis unit 6 determines a direction and a depth of cracking by pattern-matching a prestored pattern of a differential vector field of displacement around the cracking with a differential vector field (corresponding to the stress field) obtained at the differential displacement calculation unit 4 while rotating, enlarging, and reducing the prestored pattern. Herein, the prestored pattern of the differential vector field of displacement around the cracking is created in advance for each depth and each width of the cracking through a simulation and the like.

For the pattern matching, correlation operation is used. For the pattern matching, various types of other statistical operation methods may be used.

In the above, the case in which the structure 9 includes cracking has been described. Now, a case of including an internal cavity and a case of including peeling will be described below.

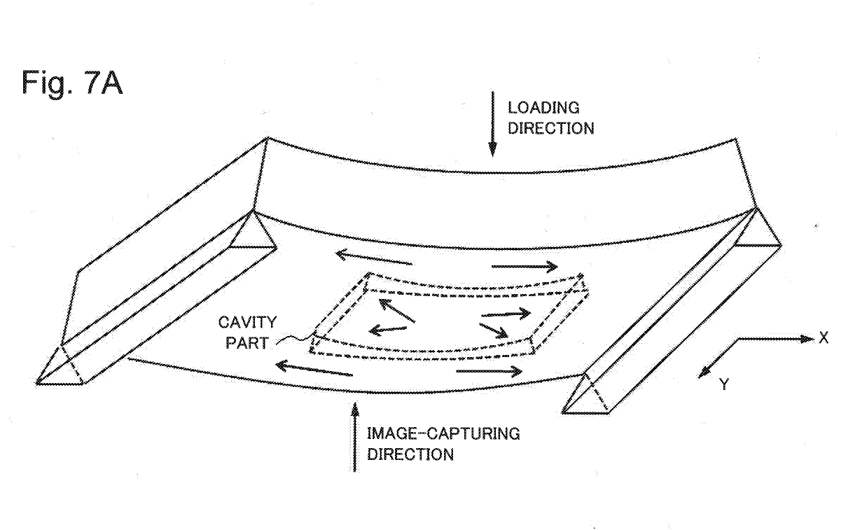

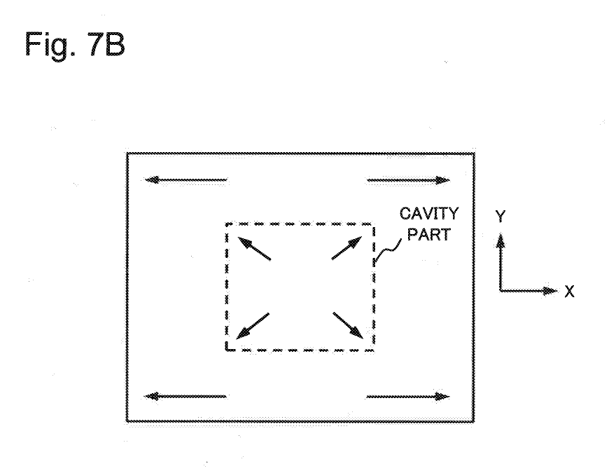

FIGS. 7A and 7B each illustrate a two-dimensional distribution of stress on a face as viewed from an image-capturing direction when an internal cavity as illustrated in FIG. 2D is present. FIG. 7A is a perspective view and FIG. 7B is a plan view. As illustrated in FIG. 7B, although the stress acts in X direction of the diagram due to a load, the stress includes a component of Y direction of the diagram since the stress field is bent at a cavity part.

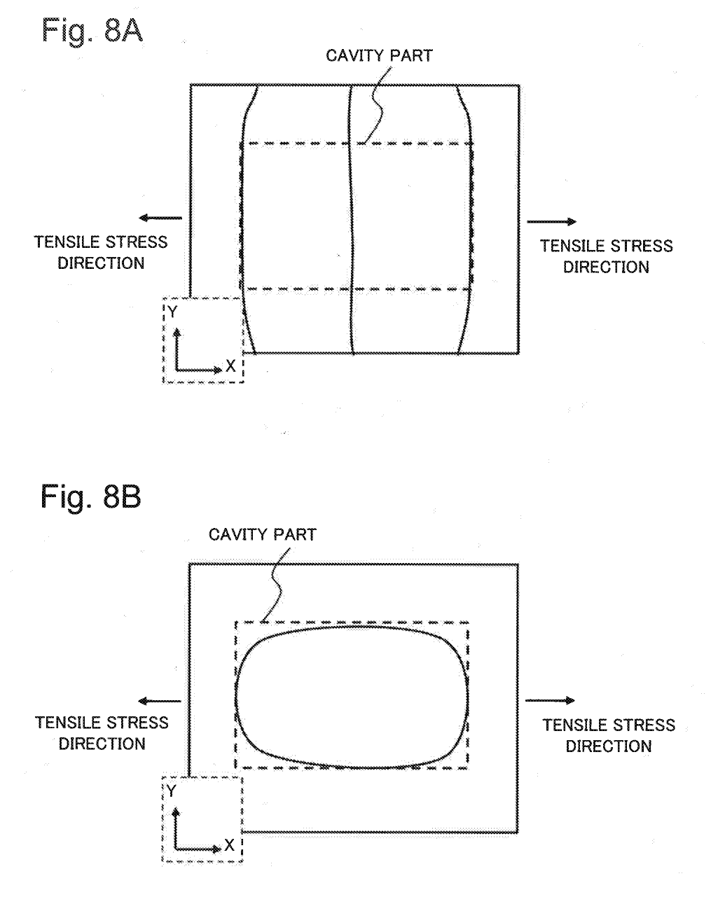

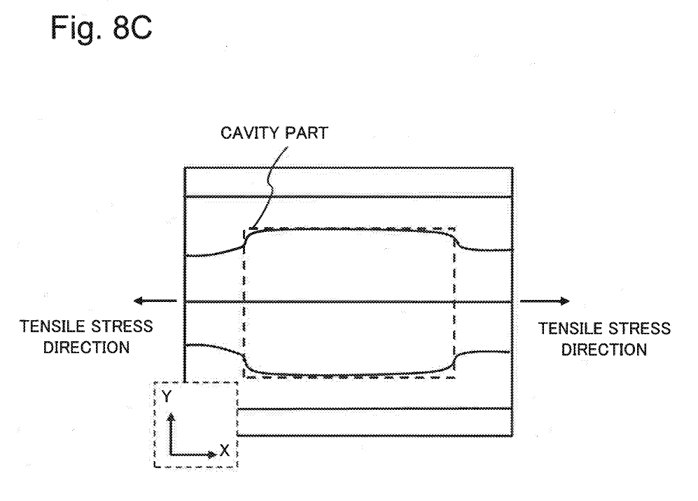

FIGS. 8A to 8C are diagrams each illustrating contour lines and a stress field of displacement on a face as viewed from an image-capturing direction when an internal cavity is present. The contour lines of displacement for X component, the contour lines of displacement for Y component, and the stress field are illustrated in FIGS. 8A, 8B, and 8C, respectively.

Since the strain amount is small at the cavity part as described in FIG. 2D, the density of the contour lines of displacement for X component illustrated in FIG. 8A is small. In addition, the contour lines of displacement for Y component illustrated in FIG. 8B are a closed curved line. Further, the stress field illustrated in FIG. 8C, which is a differential of displacement, is bent at the cavity part. Since the closer the cavity part is to the surface, the more remarkable the influence of the stress field on the surface is, a depth of the cavity part from the surface can be also estimated from the way of bending of the stress field.

Herein, a pattern of displacement around the cavity for X direction, a pattern of displacement around the cavity for Y direction, and a differential vector field (corresponding to the stress field), which are prestored at the two-dimensional spatial distribution information analysis unit 6, can be subjected to pattern matching in the same manner as in determining cracking. In other words, when FIGS. 8A, 8B, and 8C are applied to FIGS. 6A, 6B, and 6C, respectively, status determination about a location and a depth of an internal cavity can be made. For the pattern matching, correlation operation is used. However, other statistical operation methods may be used.

In addition, in the case of including an internal cavity, it can be also estimated, from the features of the Y-direction displacement amount and the Y-direction strain, that an internal cavity is present when threshold values preset for the displacement amount and the strain are exceeded.

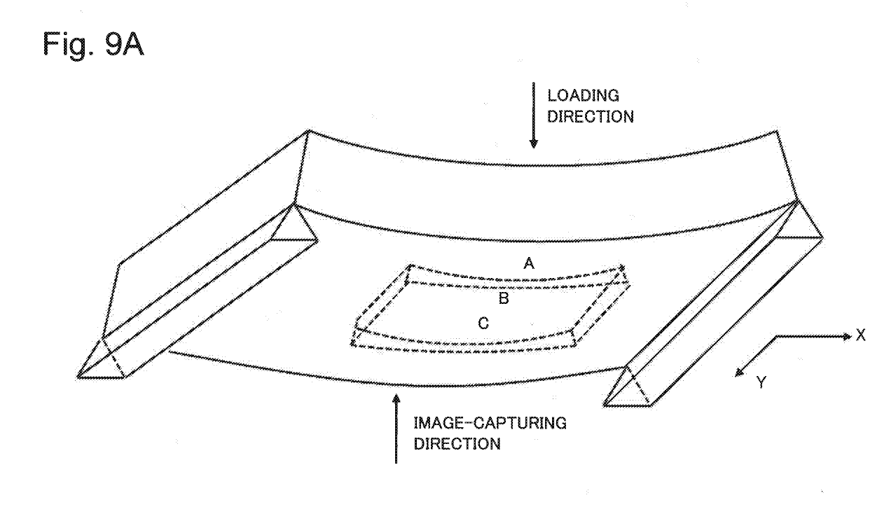

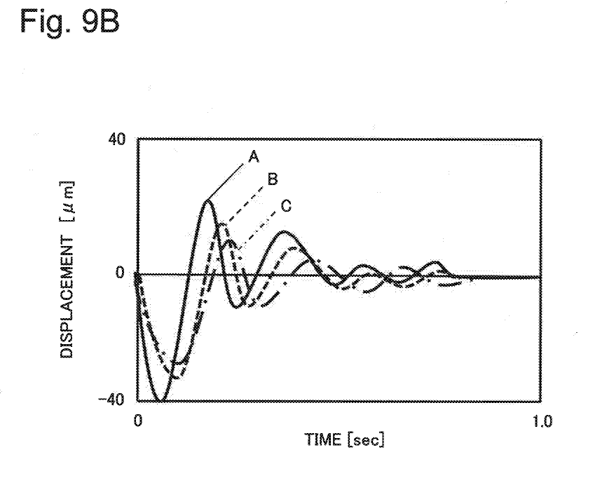

FIGS. 9A and 9B are diagrams each describing a response in a case of applying a load (referred to as an impulse stimulus) to a structure including an internal cavity for a short time. The impulse stimulus can be applied to, for example, a location where a load is applied. A time response of displacement against the impulse stimulus at points A, B, and C illustrated in FIG. 9A is illustrated in FIG. 9B. At point A where the internal cavity is absent, the stress propagation is quick and the amplitude of displacement is large. On the other hand, at point C, since the stress does not propagate through the internal cavity but propagates through the periphery of the cavity, the stress propagation is slow and the amplitude of displacement is small. In addition, at point B as an intermediate point between point A and point C, the stress propagation time and the amplitude take an intermediate value between point A and point C. Therefore, when a displacement distribution within a plane of a structure as viewed from an image-capturing direction is frequency-analyzed by the time variation information analysis unit 7 in the abnormality determination unit 5, an internal cavity region can be identified from the amplitude and the phase in the vicinity of a resonance frequency. In addition, an internal cavity may be determined from the deviation of the resonance frequency.

Note that even when applying a load for a long time, fluctuation of displacement equivalent to FIG. 9B can be observed at an initial stage of load application. However, in this case, a convergence value of the displacement is not zero but takes a value in balance with the load. Thus, in the case of applying a load for a long time, an internal cavity region can be identified by the time variation information analysis unit 7.

The above processing for a time response of displacement is carried out through frequency analysis using Fast Fourier Transform at the time variation information analysis unit 7. In addition, for the frequency analysis, various types of frequency analysis methods such as wavelet transformation may be used.

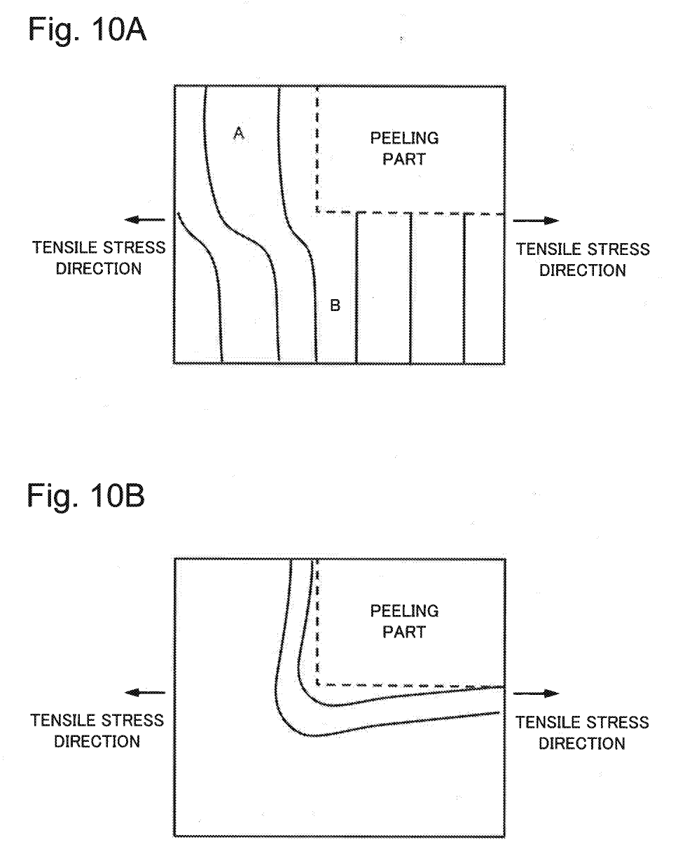

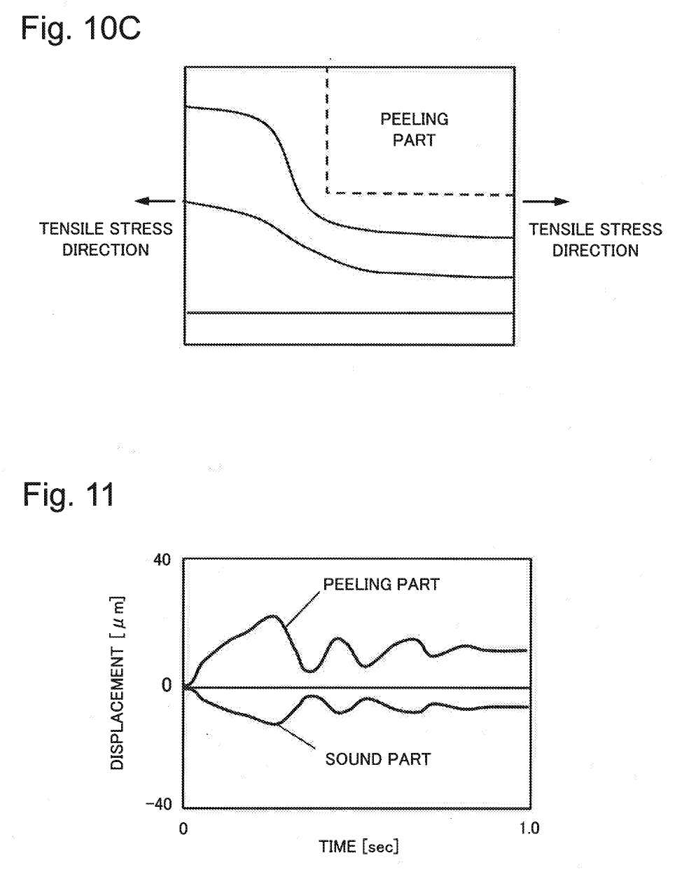

FIGS. 10A to 10C are diagrams each illustrating contour lines and a stress field of displacement on a face as viewed from an image-capturing direction when peeling is present. The contour lines of displacement for X component, the contour lines of displacement for Y component, and the stress field are illustrated in FIGS. 10A, 10B, and 10C, respectively.

When peeling is present, the appearance of the beam-shaped structure as viewed from the lower face is observed as being similar to the appearance in the case of cracking, as illustrated in FIG. 2C. However, since the stress does not propagate between a peeling part and an upper part thereof, the peeling part undergoes only a certain amount of parallel displacement in a certain direction before and after loading but does not generate a strain, which is a spatial differential value of displacement.

FIG. 10A illustrates the contour lines of displacement for X component. Since a peeling part has no strain and undergoes displacement in a certain direction, no contour line is present at the peeling part. Using this feature, the abnormality determination unit 5 determines that peeling is present. In addition, at a part at point A in the diagram, since the stress less easily propagates due to rupture caused by the peeling, the contour lines are sparse in comparison with those at point B that is a sound part. The abnormality determination unit 5 may determine a peeling part and a sound part by using this feature.

FIG. 10B illustrates the contour lines of displacement for Y component. Y-direction displacement is generated outside the outer periphery of the peeling part. Using this feature, the abnormality determination unit 5 is able to determine that peeling is present. In addition, the stress field illustrated in FIG. 10C, which is a differential of displacement, is 0 or a value in the vicinity of 0 at the peeling part. Using this feature, the abnormality determination unit 5 is able to determine that peeling is present.

Herein, a pattern of displacement around the peeling for X direction, a pattern of displacement around the peeling for Y direction, and a differential vector field (corresponding to the stress field), which are prestored at the two-dimensional spatial distribution information analysis unit 6, can be subjected to pattern matching in the same manner as in determining cracking. In other words, when FIGS. 10A, 10B, and 10C are applied to FIGS. 6A, 6B, and 6C, respectively, a location of peeling can be determined. For the pattern matching, correlation operation is used. However, other statistical operation methods may be used.

FIG. 11 is a diagram illustrating a time response when a structure including peeling receives an impulse stimulus. In the time response, directions of displacement are opposite between the peeling part and the sound part, in other words, waveforms have phases that are shifted by 180°. In addition, the peeling part has large amplitude because of its lightness. When a displacement distribution within a plane of a structure as viewed from an image-capturing direction is frequency-analyzed by the time variation information analysis unit 7, the peeling part can be identified from the amplitude and the phase. In addition, since the peeling part is lifted up from the structure as a whole and thus may sometimes contain a frequency component different from the structure as a whole, the peeling part may be identified from the deviation of the resonance frequency.

In the above processing, the frequency analysis performed by the time variation information analysis unit 7 uses Fast Fourier Transform. For the frequency analysis, various types of frequency analysis methods such as wavelet transformation may be used.

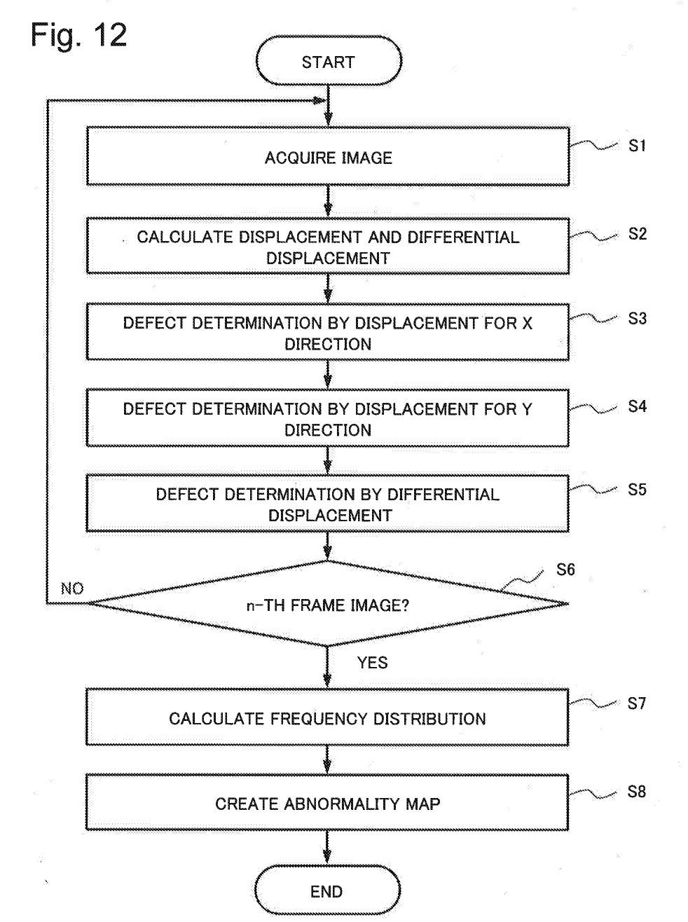

FIG. 12 is a flowchart illustrating a status determination method of the status determination device 1 in FIG. 1.

At Step S1, the displacement calculation unit 3 of the status determination device 1 takes in, among time-series images captured by the image capturing device 2 before and after load application, a frame image before load application, which serves as a reference for calculating a displacement amount before and after load application, and further takes in an initial frame image after start of load application.

At Step S2, the displacement calculation unit 3 calculates a displacement amount for each of X and Y directions of the image after loading relative to the image before load application serving as a reference. Further, the displacement calculation unit 3 may represent a two-dimensional distribution of the calculated displacement amount as a displacement distribution diagram (contour lines of the displacement amount) on X-Y plane. Further, at Step S2, the displacement calculation unit 3 inputs the calculated displacement amount or the displacement distribution diagram to the differential displacement calculation unit 4. The differential displacement calculation unit 4 spatially differentiates the input displacement amount or the input displacement distribution diagram, and calculates a differential displacement amount (stress value) or a differential displacement distribution diagram (stress field). The displacement calculation unit 3 and the differential displacement calculation unit 4 input results of the calculation to the abnormality determination unit 5.

The following Steps S3, S4, and S5 are steps for the two-dimensional spatial distribution information analysis unit 6 of the abnormality determination unit 5 to determine cracking, peeling, or an internal cavity as a defect in a structure. As examples of a method for the determination, a method of using pattern matching and a method of using a threshold value will be described.

At Step S3, the two-dimensional spatial distribution information analysis unit 6 of the abnormality determination unit 5 determines a status of cracking, peeling, or an internal cavity from the input displacement amount or the input displacement distribution diagram for X direction.

First, a determination method of using pattern matching is described. The two-dimensional spatial distribution information analysis unit 6 includes, as a database, displacement distribution patterns as illustrated in FIGS. 6A, 8A, and 10A, which are created in advance correspondingly for a width, a depth, and the like of cracking, an internal cavity, or peeling. The two-dimensional spatial distribution information analysis unit 6 determines a location and a type of a defect in X-Y plane by pattern-matching each of the displacement distribution patterns with the displacement distribution diagram for X direction input from the displacement calculation unit 3 while rotating, enlarging, and reducing the displacement distribution patterns.

Next, a determination method of using a threshold value of a displacement amount is described. The two-dimensional spatial distribution information analysis unit 6 determines, based on the input X-direction displacement amount, for example, continuity of the displacement amount. In other words, as has been illustrated in FIGS. 3A and 3C, the two-dimensional spatial distribution information analysis unit 6 determines the absence and the presence of continuity based on the presence and the absence of a sharp change equal to or greater than a threshold value in the displacement amount. When a sharp change indicating the absence of continuity is present at any location on X-Y plane, the two-dimensional spatial distribution information analysis unit 6 determines that there is a possibility that cracking or peeling is present at the concerned location. The two-dimensional spatial distribution information analysis unit 6 then sets a discontinuity flag DisC(x, y, t) to 1, and records, as numerical information, data on the displacement amount of the location where the sharp change is present. Herein, t is a time of a frame image on the time-series images taken in at Step S1.

The abnormality determination unit 5 inputs, to the abnormality map generation unit 8, the information on the defect determined by the pattern matching, or the discontinuity flag DisC(x, y, t) and the numerical information determined by using the threshold value of the displacement amount.

At Step S4, the two-dimensional spatial distribution information analysis unit 6 of the abnormality determination unit 5 determines a status of cracking, peeling, or an internal cavity from the input displacement amount or the input displacement distribution diagram for Y direction.

First, a determination method of using pattern matching is described. The two-dimensional spatial distribution information analysis unit 6 includes, as a database, displacement distribution patterns as illustrated in FIGS. 6B, 8B, and 10B, which are created in advance correspondingly for a width, a depth, and the like of cracking, an internal cavity, or peeling. The two-dimensional spatial distribution information analysis unit 6 determines a location and a type of a defect in X-Y plane by pattern-matching each of the displacement distribution patterns with the displacement distribution diagram for Y direction input from the displacement calculation unit 3 while rotating, enlarging, and reducing the displacement distribution patterns.

Next, a determination method of using a threshold value of a displacement amount is described. When cracking, peeling, or an internal cavity as a defect is present, a displacement amount is also generated in Y direction. Thus, when detecting a displacement amount larger than a predetermined threshold value, the two-dimensional spatial distribution information analysis unit 6 determines that a defect is present at the concerned location. The two-dimensional spatial distribution information analysis unit 6 then sets an orthogonality flag ortho(x, y, t) to 1, and records, as numerical information, data on the displacement amount of the location where the displacement amount larger than the threshold value is detected.

The abnormality determination unit 5 inputs, to the abnormality map generation unit 8, the information on the defect determined by the pattern matching, or the orthogonality flag ortho(x, y, t) and the numerical information determined by using the displacement amount.

At Step S5, the two-dimensional spatial distribution information analysis unit 6 of the abnormality determination unit 5 determines a status of cracking, peeling, or an internal cavity from the input differential displacement amount (stress value) or the input differential displacement distribution diagram (stress field).

First, a determination method of using pattern matching is described. The two-dimensional spatial distribution information analysis unit 6 includes, as a database, displacement distribution patterns as illustrated in FIGS. 6C, 8C, and 10C, which are created in advance correspondingly for a width, a depth, and the like of cracking, an internal cavity, or peeling. The two-dimensional spatial distribution information analysis unit 6 determines a location and a type of a defect in X-Y plane by pattern-matching each of the displacement distribution patterns with the differential displacement distribution diagram input from differential displacement calculation unit 4 while rotating, enlarging, and reducing the displacement distribution patterns.

Next, a determination method of using a threshold value of a differential displacement amount is described. For example, since a differential value of displacement diverges at a cracking part, the strain in X direction sharply increases, as illustrated in FIGS. 3B and 3D. From this fact, by presetting a threshold value for a value of the strain, it can be determined that cracking is present at a location where a strain exceeding the threshold value is detected. The two-dimensional spatial distribution information analysis unit 6 determines that cracking is present at the concerned location based on the input differential displacement amount, sets a differential value flag Diff(x, y, t) to 1, and records, as numerical information, data on the differential displacement amount at the defective location.

The abnormality determination unit 5 inputs, to the abnormality map generation unit 8, the information on the defect determined by the pattern matching, or the differential value flag Diff(x, y, t) and the numerical information determined by the differential displacement amount.

At Step S6, the displacement calculation unit 3 determines whether processing on each frame image of the time-series images is completed. In other words, in a case in which there are n frames of the time-series images, the displacement calculation unit 3 determines whether processing on the n-th frame image is completed or not. When the number of the frame images processed is less than n (NO), processing from Step S1 is repeated. This is repeated until the n frame images are completed. Note that n is not limited to a total number of frames, but can be set to an arbitrary number. When processing on the n frame images is completed (YES), the procedure proceeds to Step S7.

At Step S7, the time variation information analysis unit 7 of the abnormality determination unit 5 analyzes a time response of displacement as illustrated in FIGS. 9B and 11, from the time-series displacement amounts or the time-series displacement distribution diagrams corresponding to the n frame images. In other words, the time variation information analysis unit 7 calculates, from n displacement distribution diagrams I(x, y, n), a time-frequency distribution (where a time frequency is denoted by f) as an amplitude A(x, y, f) and a phase P(x, y, f). When the time-frequency distribution has a characteristic in the phase different depending on the locations as in FIG. 9B, the time variation information analysis unit 7 determines that an internal cavity is present at a location where a phase shift is generated. In addition, when the polarities of displacement are reversed as in FIG. 11, the time variation information analysis unit 7 determines that peeling is present at a location between the reversed polarities. The time variation information analysis unit 7 inputs, to the abnormality map generation unit 8, a result of the above calculation of the time-frequency distribution and a result of the above determination of the defect.

At Step S8, the abnormality map generation unit 8 creates an abnormality map (x, y) based on information input through the above steps. The results sent from the two-dimensional spatial distribution information analysis unit 6 and the time variation information analysis unit 7 are a group of data involved with a point (x, y) on X-Y coordinate. The group of data is used for determining a status of a structure at the two-dimensional spatial distribution information analysis unit 6 and the time variation information analysis unit 7 in the abnormality determination unit 5.

The determination by these units is made for a displacement amount or a displacement distribution diagram for X direction, a displacement amount or a displacement distribution diagram for Y direction, a differential displacement amount or a differential displacement distribution diagram, and further, a time response of displacement and differential displacement. Thus, even when a piece of data is missing, for example, even when determination cannot be made for a displacement amount for Y direction, the abnormality map generation unit 8 is able to decide a status of the concerned location on X-Y coordinate from determination made for a displacement amount for X direction and a differential displacement amount. The abnormality map generation unit 8 is then able to create an abnormality map (x, y) based on the decision.

In addition, in determination of a defect status, when determination is different among an X-direction displacement, a Y-direction displacement, and a differential displacement, a defect status may be decided by a majority vote. In addition, a defect status may be decided to be an item with the largest difference from a threshold value as a determination criterion.

In addition, the abnormality map generation unit 8 is able to represent a degree of a defect based on various types of the numerical information described above. For example, the abnormality map generation unit 8 is able to represent a width and a depth of cracking, a size of peeling, a size of an internal cavity and a depth of an internal cavity from the surface.

In addition, determination of a defect status of a structure carried out by the two-dimensional spatial distribution information analysis unit 6 and the time variation information analysis unit 7 in the abnormality determination unit 5 can be also carried out by the abnormality map generation unit 8 when creating an abnormality map (x, y). In other words, the abnormality map generation unit 8 may obtain analysis data from the two-dimensional spatial distribution information analysis unit 6 and the time variation information analysis unit 7, and may determine a defect status based on the analysis data.

In addition, the abnormality map generation unit 8 may output a result in a form of information that can be viewed directly by a person using a display device and in a form of information for a machine to read.

In the present example embodiment, for example, the image capturing device 2 has a lens focal length of 50 mm and a pixel pitch of 5 μm, which can obtain a pixel resolution of 500 μm at an object distance of 5 m. The image capturing device 2 uses an image sensor having a number of monochrome pixels of 2000 horizontal pixels and 2000 vertical pixels, which can capture an image for a range of 1 m×1 m at an object distance of 5 m. The image sensor can have a frame rate of 60 Hz.

In addition, the image correlation performed at the displacement calculation unit 3 uses sub-pixel displacement estimation by use of quadratic curve interpolation, which can estimate displacement down to 1/100 of a pixel and can obtain a displacement resolution of 5 μm. For the sub-pixel displacement estimation in the image correlation, various types of methods below can be used. In addition, for the displacement differentiation, a smoothing filter can be used for reducing noise during differentiation.

For the sub-pixel displacement estimation, interpolation using a quadratic surface, an isometric straight line, and the like may be used. In addition, for the image correlation operation, Sum of Absolute Difference (SAD), Sum of Squared Difference (SSD), Normalized Cross Correlation (NCC), Zero-mean Normalized Cross Correlation (ZNCC), and other methods of various types may be used. In addition, any combination of the above methods and the aforementioned sub-pixel displacement estimation method may be used.

The lens focal length of the image capturing device 2, the pixel pitch, the pixel number, and the frame rate of the image sensor may be changed as appropriate in accordance with an object to be measured.

In the present example embodiment, for example, it can be assumed that a beam-shaped structure corresponds to a bridge, and a load corresponds to a traveling vehicle. In the above, description has been given of an example in which a load is applied onto a beam-shaped structure. However, even in a case of a load such as a traveling vehicle that moves on a bridge, it is possible to detect cracking, an internal cavity, and peeling in the same manner. In addition, a structure made of another material with another size and shape and a load used in a loading method different from placing a load on a structure, for example, a loading method of hanging a load can be applied, as long as the structure and the load exhibit behaviors similar to the above description in terms of the mechanics of materials.

In addition, without limitation to the time-series images, an array-shaped Laser Doppler sensor, an array-shaped strain gauge, an array-shaped vibration sensor, an array-shaped acceleration sensor, and the like may be used as long as the sensor is capable of measuring a time-series signals of a spatial two-dimensional distribution for a surface displacement of a structure. The spatial two-dimensional time-series signals obtained from the array-shaped sensors may be treated as image information.

As has been described above, the present example embodiment makes it possible to distinctively detect a defect such as cracking, peeling, and an internal cavity by remotely observing a structure.

The present invention is not limited to the above example embodiment but can be subjected to various modifications within the scope of the invention as defined by the claims, and those modifications are also included within the scope of the present invention.

In addition, a part or all of the example embodiment can be described as the following Supplementary notes but the present invention is not limited to the following.

### Supplementary Notes

### (Supplementary Note 1)

A status determination device including:

a displacement calculation unit that calculates, from time-series images before and after load application to a surface of a structure, a two-dimensional spatial distribution of displacement on the surface of the structure; and

an abnormality determination unit that identifies a defect in the structure, based on comparison between the two-dimensional spatial distribution and a spatial distribution of displacement prepared in advance.

### (Supplementary Note 2)

The status determination device according to Supplementary note 1, further including

a differential displacement calculation unit that calculates, from the two-dimensional spatial distribution, a two-dimensional differential spatial distribution of the two-dimensional spatial distribution, wherein

the abnormality determination unit identifies a defect in the structure, based on comparison between the two-dimensional differential spatial distribution and a differential spatial distribution of differential displacement prepared in advance.

### (Supplementary Note 3)

The status determination device according to Supplementary note 1 or 2, wherein

the abnormality determination unit identifies a defect in the structure, based on a time variation of the two-dimensional spatial distribution.

### (Supplementary Note 4)

The status determination device according to Supplementary note 2 or 3, wherein

the abnormality determination unit identifies a defect in the structure, based on a time variation of the two-dimensional differential spatial distribution.

### (Supplementary Note 5)

The status determination device according to any one of Supplementary notes 1 to 4, wherein

the abnormality determination unit identifies a defect in the structure, based on comparison between a displacement amount of displacement of the surface of the structure and a threshold value prepared in advance.

### (Supplementary Note 6)

The status determination device according to any one of Supplementary notes 2 to 5, wherein

the abnormality determination unit identifies a defect in the structure, based on comparison between a differential displacement amount of displacement of the surface of the structure and a threshold value prepared in advance.

### (Supplementary Note 7)

The status determination device according to any one of Supplementary notes 1 to 6, further including

an abnormality map generation unit that creates, based on a result of determination of the abnormality determination unit, an abnormality map indicating a location and a type of the defect.

### (Supplementary Note 8)

The status determination device according to any one of Supplementary notes 1 to 7, wherein

a type of the defect includes cracking, peeling, and an internal cavity.

### (Supplementary Note 9)

The status determination device according to Supplementary note 8, wherein

the spatial distribution of displacement prepared in advance and the differential spatial distribution of differential displacement prepared in advance are based on information on the cracking, the peeling, and the internal cavity.

### (Supplementary Note 10)

The status determination device according to any one of Supplementary notes 1 to 9, wherein

the displacement on the surface of the structure is a difference between an image of the time-series images before the load application and an image of the time-series images after the load application.

### (Supplementary Note 11)

The status determination device according to any one of Supplementary notes 1 to 10, wherein

the two-dimensional spatial distribution includes a displacement distribution of the displacement in X direction on X-Y plane and a displacement distribution of the displacement in Y direction on X-Y plane.

### (Supplementary Note 12)

A status determination method including:

calculating, from time-series images before and after load application to a surface of a structure, a two-dimensional spatial distribution of displacement on the surface of the structure; and

identifying a defect in the structure, based on comparison between the two-dimensional spatial distribution and a spatial distribution of displacement prepared in advance.

### (Supplementary Note 13)

The status determination method according to Supplementary note 12, further including

calculating, from the two-dimensional spatial distribution, a two-dimensional differential spatial distribution of the two-dimensional spatial distribution, wherein

a defect in the structure is identified based on comparison between the two-dimensional differential spatial distribution and a differential spatial distribution of differential displacement prepared in advance.

### (Supplementary Note 14)

The status determination method according to Supplementary note 12 or 13, wherein

a defect in the structure is identified based on a time variation of the two-dimensional spatial distribution.

### (Supplementary Note 15)

The status determination method according to Supplementary note 13 or 14, wherein

a defect in the structure is identified based on a time variation of the two-dimensional differential spatial distribution.

### (Supplementary Note 16)

The status determination method according to any one of Supplementary notes 12 to 15, wherein

a defect in the structure is identified based on comparison between a displacement amount of displacement of the surface of the structure and a threshold value prepared in advance.

### (Supplementary Note 17)

The status determination method according to any one of Supplementary notes 13 to 16, wherein

a defect in the structure is identified based on comparison between a differential displacement amount of displacement of the surface of the structure and a threshold value prepared in advance.

### (Supplementary Note 18)

The status determination method according to any one of Supplementary notes 12 to 17, further including

creating, based on the result of the determination, an abnormality map indicating a location and a type of the defect.

### (Supplementary Note 19)

The status determination method according to any one of Supplementary notes 12 to 18, wherein

a type of the defect includes cracking, peeling, and an internal cavity.

### (Supplementary Note 20)

The status determination method according to Supplementary note 19, wherein

the spatial distribution of displacement prepared in advance and the differential spatial distribution of differential displacement prepared in advance are based on information on the cracking, the peeling, and the internal cavity.

### (Supplementary Note 21)

The status determination method according to any one of Supplementary notes 12 to 20, wherein

the displacement on the surface of the structure is a difference between an image of the time-series images before the load application and an image of the time-series images after the load application.

### (Supplementary Note 22)

The status determination method according to any one of Supplementary notes 12 to 21, wherein

the two-dimensional spatial distribution includes a displacement distribution of the displacement in X direction on X-Y plane and a displacement distribution of the displacement in Y direction on X-Y plane.

This application is based upon and claims the benefit of priority from Japanese Patent Application No. 2014-194538, filed on Sep. 25, 2014, the disclosure of which is incorporated herein in its entirety.

### INDUSTRIAL APPLICABILITY

The present invention can be used in a device and a system that remotely observe and detect a defect such as cracking, peeling, and an internal cavity generated in a structure such as a tunnel and a bridge.

### REFERENCE SIGNS LIST

1 Status determination device
2 Image capturing device
3 Displacement calculation unit
4 Differential displacement calculation unit
5 Abnormality determination unit
6 Two-dimensional spatial distribution information analysis unit
7 Time variation information analysis unit
8 Abnormality map generation unit
9 Structure
10 Status determination device
11 Displacement calculation unit
12 Abnormality determination unit

What is claimed is:

1. A status determination device including:
a displacement calculation circuit that calculates, from time-series images before and after load application to a surface of a structure, a two-dimensional spatial distribution of displacement on the surface of the structure; and
an abnormality determination circuit that identifies a defect in the structure, based on comparison between the two-dimensional spatial distribution and a spatial distribution of displacement prepared in advance.

2. The status determination device according to claim 1, further including
a differential displacement calculation circuit that calculates, from the two-dimensional spatial distribution, a two-dimensional differential spatial distribution of the two-dimensional spatial distribution, wherein
the abnormality determination circuit identifies a defect in the structure, based on comparison between the two-dimensional differential spatial distribution and a differential spatial distribution of differential displacement prepared in advance.

3. The status determination device according to claim 1, wherein
the abnormality determination circuit identifies a defect in the structure, based on a time variation of the two-dimensional spatial distribution.

4. The status determination device according to claim 2, wherein
the abnormality determination circuit identifies a defect in the structure, based on a time variation of the two-dimensional differential spatial distribution.

5. The status determination device according to claim 1, wherein
the abnormality determination circuit identifies a defect in the structure, based on comparison between a displacement amount of displacement of the surface of the structure and a threshold value prepared in advance.

6. The status determination device according to claim 2, wherein
the abnormality determination circuit identifies a defect in the structure, based on comparison between a differential displacement amount of displacement of the surface of the structure and a threshold value prepared in advance.

7. The status determination device according to claim 1, further including an abnormality map generation circuit that creates, based on a result of determination of the abnormality determination circuit, an abnormality map indicating a location and a type of the defect.

8. The status determination device according to claim 1, wherein
a type of the defect includes cracking, peeling, and an internal cavity.

9. A status determination method including:
calculating, from time-series images before and after load application to a surface of a structure, a two-dimensional spatial distribution of displacement on the surface of the structure; and
identifying a defect in the structure, based on comparison between the two-dimensional spatial distribution and a spatial distribution of displacement prepared in advance.

10. The status determination method according to claim 9, further including
calculating, from the two-dimensional spatial distribution, a two-dimensional differential spatial distribution of the two-dimensional spatial distribution, wherein
a defect in the structure is identified based on comparison between the two-dimensional differential spatial distribution and a differential spatial distribution of differential displacement prepared in advance.
